(19) United States
(12) Patent Application Publication
(10) Pub. No.: US 2025/0220766 A1
(43) Pub. Date: Jul. 3, 2025

(54) RANDOMIZING SIGNALLING DURING DISCONTINUOUS COVERAGE AREA IN SATELLITE ACCESS NETWORK

(71) Applicant: Samsung Electronics Co., Ltd., Suwon-si, Gyeonggi-do (KR)

(72) Inventors: Aman AGARWAL, Bangalore (IN); Avneesh TIWARI, Bangalore (IN); Kailash Kumar JHA, Bangalore (IN); Lalith KUMAR, Bangalore (IN); Dongyeon KIM, Suwon-si (KR); Mahmoud WATFA, Staines (GB)

(21) Appl. No.: 18/843,918

(22) PCT Filed: Mar. 7, 2023
(86) PCT No.: PCT/KR2023/003075

§ 371 Date: Sep. 4, 2024

(30) Foreign Application Priority Data
Mar. 11, 2022 (IN) 202241013349
Mar. 17, 2022 (IN) 202241014699
Feb. 21, 2023 (IN) 202241013349

(51) Int. Cl. H04W 76/28; H04W 60/04; H04W 84/04; H04W 84/06

(52) U.S. Cl. CPC H04W 76/28; H04W 60/04; H04W 84/042; H04W 84/06

(57) ABSTRACT

The disclosure relates to a 5G or 6G communication system for supporting a higher data transmission rate. Embodiments herein provide a method for randomizing signalling during a discontinuous coverage area in a satellite access apparatus by a UE. The method includes registering the UE to the satellite access apparatus through a satellite access network. Further, the method includes receiving a discontinuous coverage wait range from the satellite access network. Further, the method includes detecting a discontinuous coverage in the satellite access apparatus. Further, the method includes determining a random wait time within the discontinuous coverage wait range. Further, the method includes starting a wait timer configured with the determined random wait time based on the determination, when the UE returns to coverage after being out of coverage on the satellite access apparatus and waiting for the expiry or stop of the wait timer to initiate an access stratum (AS) signalling or a Non-access stratum (NAS) signalling on the satellite access network.

### TECHNICAL FIELD

The disclosure relates to a wireless communication and systems, and more particularly related to a method and a system to randomize User Equipment (UE) and network signalling during a discontinuous coverage area in a satellite access network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The embodiments of the disclosure may provide a method and systems to randomize User Equipment (UE) and network signalling during a discontinuous coverage area in a satellite access network. The satellite access network configures a random wait range/wait timer for the UE(s) based on the priority of the UE(s) or based on the priority of the services. After satellite coverage is back or when the UE is about to leave Satellite coverage (i.e. when the UE is just about to go out of Satellite coverage or when the UE is about to go into discontinuous coverage), different UE(s) wait for a different random wait timer before initiating a signalling to the satellite access network. Thus, the signalling to the satellite access network is randomized and there is no spike in the signalling and the satellite access network is not overloaded.

The embodiments of the disclosure may provide a method and systems for prioritizing UEs in the satellite access network, wherein the UE is in a discontinuous coverage area and the network is a non-terrestrial network (NTN).

### Solution to Problem

Accordingly the embodiment herein is to provide a method for randomizing signalling during a discontinuous coverage area in a satellite access network. The method includes registering, by a UE, to the satellite access apparatus through a satellite access network. Further, the method includes receiving, by the UE, a discontinuous coverage wait range or any wait range (or any timer range with any name) from the satellite access network. Further, the method includes detecting, by the UE, a discontinuous coverage in the satellite access apparatus. Further, the method includes determining, by the UE, a random wait time or any time with any name within the discontinuous coverage wait range or the timer range signalled/configured by the Network. Further, the method includes starting, by the UE, a wait timer configured with the determined random wait time based on the determination, when the UE returns to coverage after being out of coverage on the satellite access apparatus and waiting for the expiry or stop of the wait timer to initiate an access stratum (AS) signalling or a Non-access stratum (NAS) signalling on the satellite access network.

In an embodiment, the satellite access network is at least one of an Access and Mobility Management Function (AMF) entity and a mobility management entity (MME).

In an embodiment, the satellite access apparatus is at least one of a Public Land Mobile Network (PLMN) and a Radio Access Technology (RAT).

In an embodiment, further, the method includes detecting, by the UE, the wait timer is running. Further, the method includes wait to initiate, by the UE, the AS signalling or the NAS signalling on satellite access network when the wait timer is running.

In an embodiment, the discontinuous coverage wait range is configured in the UE by the satellite access network as part of at least one of a registration procedure, a UE configuration update procedure, a UE parameters update procedure, an attach procedure, a Tracking Area Update (TAU) procedure and a control plane procedure.

Accordingly the embodiment herein is to provide a method for randomizing signalling during discontinuous coverage area in a satellite access network. The method includes registering, by a satellite access network, a user equipment (UE) in the satellite access apparatus. Further, the method includes determining, by the satellite access network, a discontinuous coverage wait range based on network configuration. The network configuration can be on the basis of any parameters such as UE's subscription, UE priority, Type of the UE, Priority of the services, Type of the services, Network deployment for Satellite Access or Terrestrial Access, Network load handling capability, Network Resource handling capability etc. For example, the discontinuous coverage wait range may be assigned by the Satellite Access Network based on the priority of the UE/Users or based on the priority/type of services or as per UE's subscription data like Group ID or Type of Subscription or as per Access Identities or Access Categories (for e.g. Based on Priority of the UE(s)/User(s)/Services (i.e. or Group ID/Type of Subscription/Subscriber profile/Type of Services subscribed by the UE etc), the Network may assign a lesser or zero discontinuous coverage wait range to the higher priority UE(s)/User(s)/Services in comparison to high discontinuous coverage wait range to low priority UE(s)/User(s)/Services).) Further, the method includes sending, by the satellite access network, the discontinuous coverage wait range to the UE through a registration procedure with the UE or a UE configuration update procedure, wherein the UE remains in no service during the discontinuous coverage and wait for expiry or stop of the wait timer to initiate AS or NAS signalling after coming out of the discontinuous coverage.

In general, the method includes any information (for e.g. wait range information or any other information or any timer range information of any name) to be broadcasted or signalled or configured or pre-configured by any Network Element/Entity/Function in the UE. Further, the method includes determining by the UE, a wait time (or any time information of any name) within the wait range/timer range information signalled/configured by the network. Further, the method includes starting by the UE, a wait timer (or any timer information of any name) configured with the determined wait time (or any time information of any name) based on the determination when the UE returns to coverage after being out of coverage on the satellite access apparatus or when the UE moves to another/alternate Network/Access/RAT when determining being out of coverage on the satellite access apparatus or when the UE is about to go out of coverage on the satellite access apparatus or the source Network/RAT/Access. Further, the method includes waiting, by the UE, for the expiry or stop of the wait timer to initiate an access stratum (AS) signalling or a Non-access stratum (NAS) signalling on the satellite access network or any other Network/RAT/Access.

Accordingly the embodiment herein is to provide a UE for randomizing signalling during discontinuous coverage area in a satellite access network. The UE includes a randomization controller communicatively coupled to a memory and a processor. The randomization controller is configured to register to the satellite access apparatus through a satellite access network. Further, the randomization controller is configured to receive a discontinuous coverage wait range from the satellite access network. Further, the randomization controller is configured to detect a discontinuous coverage in the satellite access apparatus and determine a random wait time within the discontinuous coverage wait range. Further, the randomization controller is configured to start a wait timer configured with the determined random wait time based on the determination, when the UE returns to coverage after being out of coverage on the satellite access apparatus and waiting for the expiry or stop of the wait timer to initiate an access stratum (AS) signalling or a Non-access stratum (NAS) signalling on the satellite access network.

Accordingly the embodiment herein is to provide a satellite access network for randomizing signalling during discontinuous coverage area in a satellite access apparatus. The satellite access network includes a randomization controller communicatively coupled to a memory and a processor. The randomization controller is configured to register a user equipment in the satellite access apparatus and determine a discontinuous coverage wait range based on network configuration. Further, the randomization controller is configured to send the discontinuous coverage wait range to the UE through a registration procedure with the UE or a UE configuration update procedure. The UE remains in no service during the discontinuous coverage and wait for expiry or stop of the wait timer to initiate AS or NAS signalling after coming out of the discontinuous coverage.

Accordingly the embodiment herein is to provide a method for managing discontinuous satellite access by a UE. The method includes initiating, by the UE, a registration procedure for a satellite access. Further, the method includes receiving, by the UE, a discontinuous coverage wait range as part of registration procedure. Further, the method includes detecting, by the UE, a discontinuous coverage in the satellite access. Further, the method includes computing by the UE, a random wait time within the discontinuous coverage wait range. Further, the method includes starting, by the UE, a wait timer configured with the determined random wait time based on the computation, when the UE returns to coverage after being out of coverage on the satellite access apparatus. The UE will not initiate an AS signalling or a NAS signalling for the satellite access till expiry of the wait timer or till the wait timer is stopped.

Accordingly the embodiment herein is to provide a UE for managing discontinuous satellite access. The UE includes a randomization controller communicatively coupled to a memory and a processor. The randomization controller is configured to initiate a registration procedure for a satellite access and receive a discontinuous coverage wait range as part of registration procedure. Further, the randomization controller is configured to detect a discontinuous coverage in the satellite access and compute a random wait time within the discontinuous coverage wait range. Further, the randomization controller is configured to start a wait timer configured with the determined random wait time based on the computation, when the UE returns to coverage after being out of coverage on the satellite access apparatus. The UE will not initiate an access stratum (AS) signalling or a Non-access stratum (NAS) signalling for the satellite access till expiry of the wait timer or till the wait timer is stopped.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

The embodiments of the disclosure may provide a method and systems to randomize UE and network signalling during a discontinuous coverage area in a satellite access network. The satellite access network configures a random wait range/wait timer for the UE(s) based on the priority of the UE(s) or based on the priority of the services. After satellite coverage is back or when the UE is about to leave Satellite coverage (i.e. when the UE is just about to go out of Satellite coverage or when the UE is about to go into discontinuous coverage), different UE(s) wait for a different random wait timer before initiating a signalling to the satellite access network. Thus, the signalling to the satellite access network is randomized and there is no spike in the signalling and the satellite access network is not overloaded.

The embodiments of the disclosure may provide a method and systems for prioritizing UEs in the satellite access network, wherein the UE is in a discontinuous coverage area and the network is an NTN.

### BRIEF DESCRIPTION OF DRAWINGS

The method and the satellite access network are illustrated in the accompanying drawings, throughout which like reference letters indicate corresponding parts in the various figures. The embodiments herein will be better understood from the following description with reference to the drawings, in which:

FIG. 1 illustrates an example scenario of interfacing between nodes to which an embodiment is applicable;

FIG. 2 illustrates an example scenario in which updating of tracking area code (TAC) and Public Land Mobile Network identifier (PLMN ID) in real-time is depicted, when a UE location information is unavailable, to which an embodiment is applicable;

FIG. 3 illustrates a scenario of how the UE(s) trigger signalling towards the network at the same time when the UE(s) are out of discontinuous coverage of the NR satellite access network, to which an embodiment is applicable;

FIG. 4 illustrates an example scenario where the satellite access network will page a large number of UEs in a coverage area, to which an embodiment is applicable; and

FIG. 5 illustrates an overview of the satellite access network for randomizing signalling during discontinuous coverage area, according to an embodiment of the disclosure;

FIG. 6 illustrates various hardware components of a UE, according to an embodiment of the disclosure;

FIG. 7 illustrates various hardware components of a satellite access network, according to an embodiment of the disclosure;

FIG. 8 illustrates a flow chart illustrating a method, implemented by the UE, for randomizing the signalling during the discontinuous coverage area in the satellite access network (or managing discontinuous satellite access), according to an embodiment of the disclosure;

FIG. 9 illustrates a flow chart illustrating a method, implemented by the satellite access network, for randomizing the signalling during the discontinuous coverage area in the satellite access network (or managing discontinuous satellite access), according to an embodiment of the disclosure;

FIG. 10 illustrates an example scenario of how to ensure UE(s) don't trigger signalling towards the network at the same time when the UE(s) are out of discontinuous coverage of the NR Satellite Access Network at the same time, according to an embodiment of the disclosure;

FIG. 11 illustrates an example method for prioritizing UEs in a Non Terrestrial Network (NTN) coverage area, according to an embodiment of the disclosure;

FIG. 12 illustrates an electronic device according to an embodiment of the disclosure; and

FIG. 13 illustrates a node according to an embodiment of the disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In discontinuous coverage of a satellite scenario, a User Equipment's (UE(s)) may have coverage at only specific times due to a continuous movement of satellites or satellite constellations. When the UE(s) are about to get a satellite coverage after specific time, the UE may initiate signalling towards a network (e.g., 3GPP satellite access network or new radio (NR) satellite access network) due to any Uplink (UL) traffic or a Non Access Stratum (NAS) layer signalling.

Similarly, when the network has buffered any downlink data, the network may page the UE on determining that the UE is back in coverage. The network may also trigger any Downlink (DL) signalling when the network determines that the UE is back in coverage.

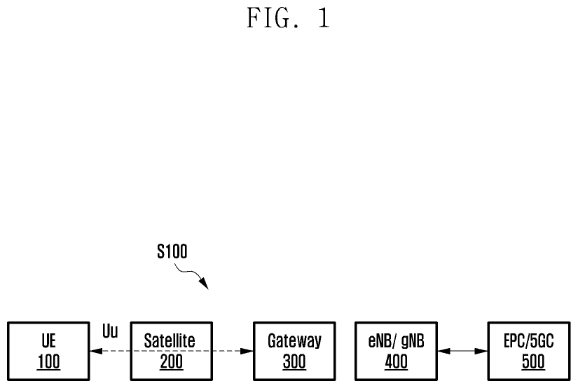

FIG. 1 illustrates an example scenario (S100) of interfacing between nodes to which an embodiment is applicable. As shown in FIG. 1, the UE (100) interacts with a gateway (300) through a satellite (200) and an eNB/gNB (400) interacts with an Evolved Packet Core (EPC)/5G Core (5GC) (500), respectively. The following terms used in the patent disclosures:
a. Continuous Coverage: In Non Terrestrial Networks (NTN), continuous satellite coverage can be characterized by the fact that an Uu interface is available for the UE (100), at a given position for 100% of the time.
b. Discontinuous Coverage (DC): In Non Terrestrial Networks (NTN), Discontinuous satellite coverage can be characterized by the fact that Uu interface is available for the UE (100), at a given position, less than 100% of the time, due to predictable lack of satellite coverage. Due to the Discontinuous coverage, the UE (100) may have access to satellite service coverage only at specific time and places.
c. Satellite ephemeris Information: Global Positioning System (GPS) satellites transmit information about their location (current and predicted), timing and “health” via what is known as ephemeris data. This data is used by the GPS receivers to estimate location relative to the satellites and thus position on earth. The Ephemeris data can also be used to predict future satellite conditions (for a given place and time) providing a tool for planning when (or when not) to schedule GPS data collection.

In other words, due to the discontinuous coverage, the UE (100) may have access to satellite service coverage only at specific times and places. This can be due to the continuous movement of the satellites or satellite constellations. When UEs are about to get the satellite coverage after a specific time, a large number of UE(s) may initiate a signalling towards the Network at the same time which can lead to congestion in the Network. Also, the coverage area may have a large number of UEs to page in the DL, which can lead to the problem of selection of the UEs (100) to page simultaneously and thus effective network (NW) resource allocation is affected. Also due to mobility of the UEs (100), the coverage area timing can be changed due to relative motions of satellites and UEs.

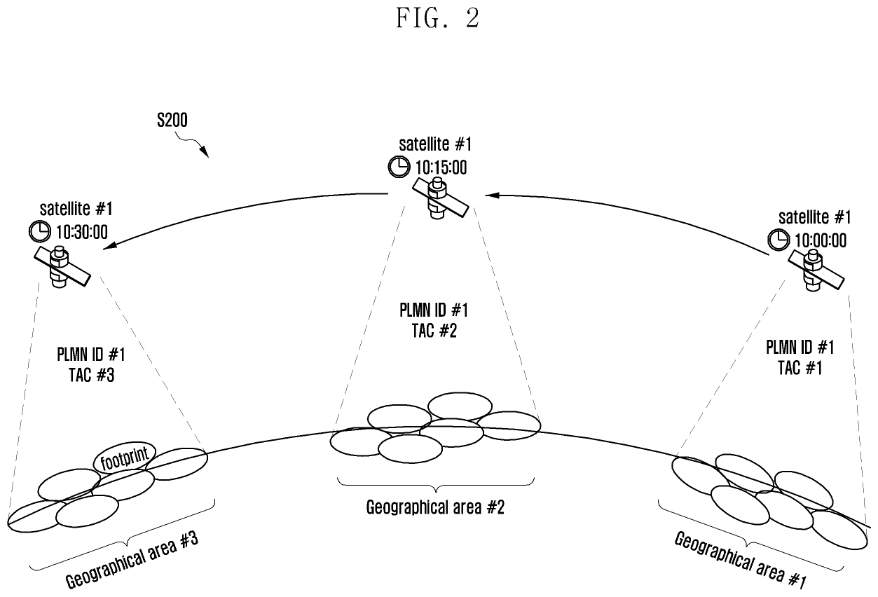

FIG. 2 illustrates an example scenario (S200) in which updating of tracking area code (TAC) and Public Land Mobile Network identifier (PLMN ID) in real-time is depicted, when a UE location information is unavailable, to which an embodiment is applicable. Referring to the FIG. 2, in order not to have TAU performed frequently by the UE (100) triggered by the satellite motion, the tracking area may be designed to be fixed on ground. For a Non Terrestrial Networks Low Earth Orbit (NTN LEO), this implies that while the cells sweep on the ground, the tracking area code (i.e. TAC) broadcasted is changed when the cell arrives to the area of next planned earth fixed tracking area location. The TAC, or a list of TACs, broadcasted by the gNB (400) needs to be updated as the gNB (400) enters to the area of next planned tracking area. When the UE (100) detects entering a tracking area that is not in the list of tracking areas that the UE (100) previously registered in the network, a mobility registration update procedure will be triggered.

The network updates the broadcast TAC in real time according to the ephemeris information and confirms the broadcast TAC is associated with the geographical area covered by the satellite beam. The UE (100) listens to that TAI is equal to PLMN ID+TAC and determines to trigger registration area update procedure based on the broadcast TAC and PLMN ID when the UE (100) moves out of the registration area. This approach allows to use Rel-15 NR network procedures and can be applied to UE (100) with or without location information.

There is another approach for the case when the UE location information is available. One possible way is to divide the earth into a lot of geographical areas and each geographical area is mapped to a certain TAC. During the initial registration, the UE (100) derives the TAC based on its location information (the mapping rule between the geographical area and the TAC value is kept both on UE side and network side), forms the TAI based on the derived TAC and broadcast PLMN ID and reports the TAI to network via a Registration ReqUE(s)t message. An AMF entity confirms the reported TAI and includes a TAI list as a registration area the UE is registered to in the Registration Accept message.

When the UE (100) moves to a new geographical area, the UE (100) derives the TAC based on the location information and forms the TAI based on the derived TAC and PLMN ID. When the UE (100) detects entering a tracking area that is not in the list of tracking areas that the UE (100) was previously registered to, a mobility registration update procedure will be triggered. The UE (100) reports the TAI derived by itself to network via Registration ReqUEst message. The AMF entity confirms the reported TAI and include a new TAI list for the UE (100) in the Registration Accept message. The UE (100), upon receiving a Registration Accept message, shall delete its old TAI list and store the received TAI list.

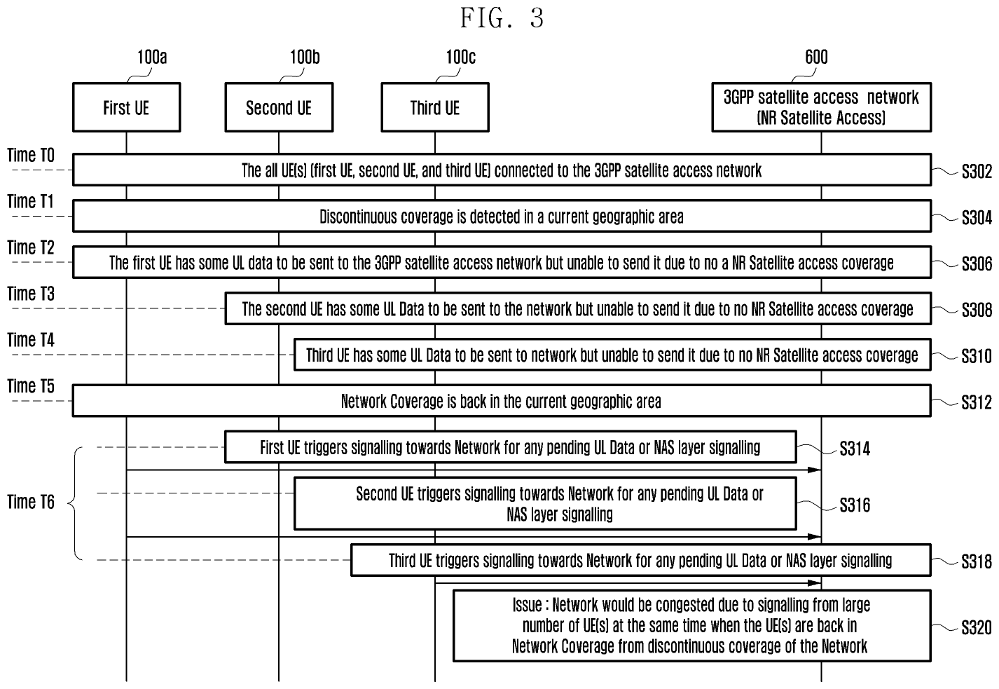

FIG. 3 illustrates a scenario of how the UE(s) (100a-100c) trigger signalling towards the network (600) at the same time when the UE(s) (100a-100c) are out of discontinuous coverage of the NR satellite access network (600), to which an embodiment is applicable.

In terrestrial networks, it is not generally required that a large number of the UE(s) (100a-100c) initiate a signalling or scan for available cell due to the UL traffic or NAS layer signalling at the same time. However, for the UE(s) (100a-100c) using a NGRAN or the eNodeB (400) that provides the discontinuous coverage (e.g. for satellite access with discontinuous coverage), the UE(s) (100a-100c) may be out of NR satellite Access network coverage at a certain time and all the UE(s) may detect NR Satellite Access Network Coverage is available at the same time. In this case, NR Satellite Access Network is stated as an example. It could be any of the NR or LTE or any Satellite Access Network. The UE(s) (100a-100c) might have some UL traffic (due to data request or signalling requirements) when the NR Satellite Coverage was not available. The UE(s) (100a-100c) may wake up to scan for available network at the same time due to any pending UL traffic or NAS layer signalling (for e.g. Periodic Registration).

When there are a large number of UE(s) (100a-100c) in the same geographic area (e.g. TA) which detect NR satellite access Network Coverage is available at the same time, there is a possibility that all these large number of UE(s) (100a-100c) may scan for available network at the same time and may initiate a signalling towards the NR satellite access Network at the same time for any pending UL traffic or NAS layer signalling (for e.g. Periodic Registration). This may lead to the network congestion.

Similarly, when the NR satellite access is not available or if the UE (100a-100c) moves out of the coverage area of the NR satellite access or if the UE (100a-100c) receives a reject message from the network in any of the AS/NAS signalling message indicating that the UE is not allowed to use satellite access in a current PLMN and there is no other PLMN providing NR Satellite access in the same area, then the UE (100a-100c) may scan for available Network/RAT(s) in other 3GPP Access (for e.g. terrestrial access) creating a high amount of load on the another RAT's (Radio access technologies) and may perform PLMN selection.

When there are a large number of UE(s) (100a-100c) in the same geographic area (e.g. TA) which were initially on the NR Satellite Access and detect NR Satellite Access Coverage is not available and scan for available Network/RAT(s) in other 3GPP Access (for e.g. terrestrial access) or perform PLMN selection at the same time, there is a possibility that all these large number of UE(s) (100a-100c) may scan for available Network/RAT(s) in other 3GPP Access (for e.g. terrestrial access like NR) at the same time and may initiate a AS/NAS signalling towards the Network at the same time. This may lead to the network congestion on another RAT of terrestrial network. An illustration is demonstrated in FIG. 3, at time TO, the first UE (UE-1), a second UE (UE-2) and a third UE (UE-3) are connected to the network (600), at time T1 discontinuous coverage is detected in the current area by all this UEs (100a-100c). At time T2, the UE-1 have pending uplink (UL) signalling or data, at T2 there is a pending uplink (UL) signalling or data for the UE-2, at T3 there is a pending uplink (UL) signalling or data for the UE-3. Though data/signalling is triggered at different instants of time all the UEs (100a-100c) were blocked to send any data or signalling at time T5 all UEs (100a-100c) detect that network coverage is available. At time T6 all the UEs (100a-100c) attack the network to send the uplink data or signalling creating tremendous load on network at that instant of time.

Referring to FIG. 3, At S302, all UE(s) (100a-100c) (the first UE, the second UE, and third UE) are connected to the 3GPP satellite access network (600). At S304, the discontinuous coverage is detected in the current geographic area. At S306, the first UE (100a) has some UL Data to be sent to the network (600) but unable to send it due to no NR satellite access coverage. At S308, the second UE (100b) has some UL data to be sent to the network (600) but unable to send it due to no NR satellite access coverage. At S310, the third UE (100c) has some UL data to be sent to the network (600) but unable to send it due to no NR satellite access coverage. At S312, the network coverage is back in the current geographic area.

At S314, the first UE (100a) triggers the signalling towards the network (600) for any pending UL Data or NAS layer signalling. At S316, the second UE (100b) triggers signalling towards the network (600) for any pending UL Data or NAS layer signalling. At S318, the third UE (100c) triggers signalling towards the network (600) for any pending UL Data or NAS layer signalling. At S320: the network (600) would be congested due to signalling from large number of UE(s) (100a-100c) at the same time when the UE(s) (100a-100c) are back in the network coverage from discontinuous coverage of the network (600).

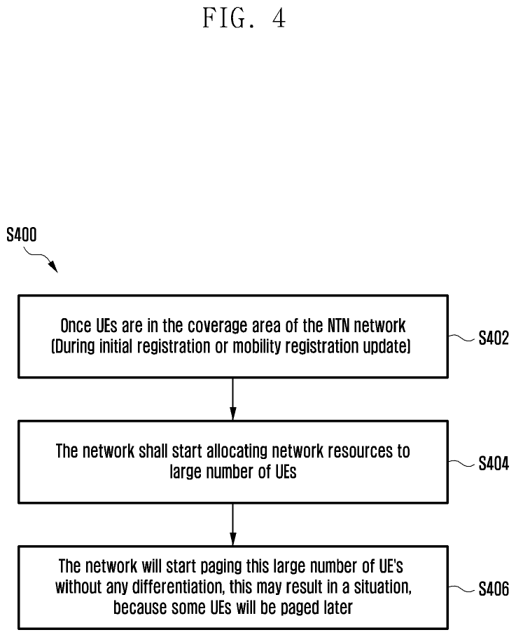

Also, in the TNs, it is not practically required that paging has to be done for thousands of the UEs (100a-100n) at the same time rather whenever data is generated for the UE, either the UE is in connected mode or the UE needs to paged immediately. But in the NTNs, due to discontinuous coverage, a large number of UEs (100a-100n) are blocked of paging and they are all in queue to send the data. When the network determines that the UE is in the coverage area (for example, based on initial registration or mobility registration update procedure), the network will start allocating resources to large number of UEs for the paging or DL data. Now, the network will start paging these large number of UE's without any differentiation, this may result in a situation, because some UEs will be paged later. This scenario has been depicted in FIG. 4.

Referring to FIG. 4, at S402, once UEs (100a-100n) are in the coverage area of the NTN network (for example—any Satellite Network or any 3GPP Satellite Network) during initial registration or mobility registration update. At S404, the network shall start allocating network resources to large number of UEs (100a-100n). At S406, the network (600) will start paging this large number of UE's (100a-100n) without any differentiation, this may result in a situation, because some UEs (100a-100n) will be paged later.

Also, in the TNs, the UE's mobility can be easily handled via mobility update procedures, but in case of NTNs, due to mobility of UE's, the periodic coverage area time (i.e., the time in which a satellite will come again to the same geographical location after earth sweep) can be delayed or can be early depending upon the relative motions of the satellites and UEs. When the UE and the satellite both are in motion in the same direction and are in comparatively similar speeds (i.e., the UE speed will be lower than the speed of the satellite), due to the relative motion, the coverage area time will be delayed. This delay will lead to the UE (100) sending unnecessary MO signalling in order to connect to the networks, when in a non-coverage area of the satellite.

Similarly, when the UE (100) and the satellite both are in motion in opposite directions and are in comparatively similar speeds (i.e., the UE speed will be lower than the speed of the satellite), due to the relative motion, the coverage area time will be early. The UE will not be able to connect to the network as the UE is not aware of the coverage area of the satellite.

Currently, there is no method to handle this above situation and a method needs to be defined.

Accordingly, the embodiment herein is to provide a method for randomizing signalling during a discontinuous coverage area in a satellite access network. The method includes registering, by a UE, to the satellite access apparatus through a satellite access network. Further, the method includes receiving, by the UE, a discontinuous coverage wait range from the satellite access network. Further, the method includes detecting, by the UE, a discontinuous coverage in the satellite access apparatus. Further, the method includes determining, by the UE, a random wait time within the discontinuous coverage wait range. Further, the method includes starting, by the UE, a wait timer configured with the determined random wait time based on the determination, when the UE returns to coverage after being out of coverage on the satellite access apparatus and waiting for the expiry or stop of the wait timer to initiate an access stratum (AS) signalling or a Non-access stratum (NAS) signalling on the satellite access network.

In the proposed methods, the satellite access network (e.g., HPLMN or the Registered PLMN/VPLMN) can configure the wait timer/wait range (for e.g. discontinuous coverage wait range) which the UE(s) can use before the UE(s) initiate a signalling/registration procedure towards the Network. The network can be at-least one of a Source RAT, a source PLMN, a source Access, a target RAT, a target PLMN, or any combination of these. This shall randomize the UE(s) signalling from different UE(s) to avoid signalling overload or network congestion.

Some of the abbreviations used in the patent description is as follows:
1. NTN—Non Terrestrial Networks
2. UE—User Equipment
3. eNB—Evolved Node-B
4. gNB—Next generation Node-B
5. EPC—Evolved Packet Core
6. 5GC—5G Core
7. DC—Discontinuous Coverage
8. GPS—Global Positioning System
9. DL—Downlink
10. UL—Uplink
11. NW—Network
12. QoS—Quality Of Service
13. ARP—Allocation and Retention Policy
14. MCS—Mission Critical Service
15. MPS—Multimedia Priority Service
16. 3GPP—Third Generation Partnership Project
17. ME—Mobile Equipment
18. USIM—Universal Subscriber Identification Module
19. Uu—The radio interface between the UE and the Node B
20. Satellite—an artificial body placed in orbit round the earth or moon or another planet in order to collect information or for communication.
21. Satellite Constellation—Group of satellites, placed in orbit round the earth or moon or another planet in order to collect information or for communication.
22. Service User—An individual who has received a priority level assignment from a regional/national authority (i.e., an agency authorised to issue priority assignments) and has a subscription to a mobile network operator
23. TER—Terrestrial
24. SAT—Satellite
25. TN—Terrestrial Networks
26. PLMN—Public Land Mobile Network
27. FR—Frequency Range
28. HPLMN—Home PLMN
29. VPLMN—Visited PLMN
30. AS—Access Stratum
31. NAS—Non-Access Stratum
32. RAT—Radio Access Technology
33. 3GPP—3rd Generation Partnership Project
34. GEO—Geostationary Orbit
35. LEO—Low Earth Orbit
36. MEO—Medium Earth Orbit
37. RAT—Radio Access Technology

Example list of NAS messages, which is not limited to, as follows:
a) REGISTRATION REQUEST message;
b) DEREGISTRATION REQUEST message;
c) SERVICE REQUEST message;
d) CONTROL PLANE SERVICE REQUEST;
e) IDENTITY REQUEST;
f) AUTHENTICATION REQUEST;
g) AUTHENTICATION RESULT;
h) AUTHENTICATION REJECT;
i) REGISTRATION REJECT;
j) DEREGISTRATION ACCEPT;
k) SERVICE REJECT;
l) SERVICE ACCEPT;
m) UE CONFIGURATION UPDATE command;
n) UE PARAMETERS UPDATE command;

The term RAT as defined in this embodiment can be one of the following:
(1) NG-RAN,
(2) 5G, 4G, 3G, 2G,
(3) EPS, 5GS,
(4) NR,
(5) NR in unlicensed bands,
(6) NR(LEO) satellite access,
(7) NR(MEO) satellite access,
(8) NR(GEO) satellite access,
(9) NR(OTHERSAT) satellite access,
(10) NR RedCap,
(11) E-UTRA,
(12) E-UTRA in unlicensed bands,
(13) NB-IoT,
(14) WB-IoT, and
(15) LTE-M

The terms Satellite 3GPP access, Satellite access, Satellite Access Network, NR Satellite Access Network, Satellite Next Generation Radio Access Network (NG-RAN) Access Technology and NR Satellite access have been interchangeably used and have the same meaning. The methods, issues or solutions disclosed in an embodiment are explained using NR satellite access or Satellite NG-RAN Access Technology as an example and is not restricted or limited to NR Satellite access only. However, the solutions proposed in this embodiment are also applicable for Satellite Evolved Universal Mobile Telecommunication Access Network (E-UTRAN) access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture. The solutions which are defined for NR (5GC) are also applicable to legacy Radio Access Technology (RAT) like E-UTRA/LTE, the corresponding CN entities needs to be replaced by Long Term Evolution (LTE) entities for e.g. Access and Mobility Management Function (AMF) with Mobility Management Entity (MME), Next generation Node-B (gnodeB) with evolved-nodeB (e-nodeB), UDM with HSS etc. But principles of the solution remains same. An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in the embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc. The messages used or indicated in the embodiment are shown as an example. The messages could be any signalling messages between the UE and the Network Functions/Entities or between different Network functions/entities. The term area/location/geographical area are used in this embodiment may refer to any of cell/cell ID, Tracking Are Code (TAC)/Tracking Are Identity (TAI), Public Land Mobile Network (PLMN), Mobile Country Code (MCC)/Mobile Network Code (MNC), Latitude/longitude, CAG cell or any geographical location/coordinate.

The terms camp and register are used interchangeably and have the same meaning. The terms wait timer, DisCo wait timer, Discontinuous Coverage wait timer, Random timer, Random wait timer, DCW Timer, Disaster Return Wait timer, Disaster Roaming Wait Timer are all used interchangeably and have the same meaning i.e. these can refer to any timer value of any name as determined by the UE and, optionally, derived from the information (for e.g. within the wait range information or any other information) broadcasted or signalled or configured or pre-configured by any Network Element/Entity/Function in the UE. The terms wait range, Disco Wait Range, Discontinuous Coverage Wait Range, DCW Range, Disaster Return Wait Range, Disaster Roaming Wait Range are all used interchangeably and have the same meaning i.e. these can refer to any information (for e.g. wait range information or timer range information or any other information) broadcasted or signalled or configured or pre-configured by any Network Element/Entity/Function in the UE. The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331. The cause names in this embodiment are for illustration purpose and it can have any name. The non-access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

The terms “Satellite 3GPP access” “Satellite access” and “NR Satellite access” have been interchangeably used and have the same meaning.

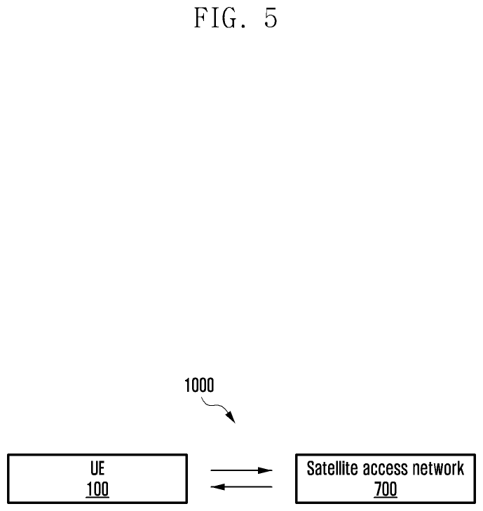

Referring now to the drawings and more particularly to FIGS. 5 through 11, where similar reference characters denote corresponding features consistently throughout the figures, there are shown preferred embodiments.

FIG. 5 illustrates an overview of a satellite access network (1000) for randomizing signalling during discontinuous coverage area, according to the embodiments as disclosed herein. In an embodiment, the satellite access apparatus (1000) includes a UE (100) and a satellite access network (700). The satellite access network (700) can be, for example, but not limited to an Access and Mobility Management Function (AMF) entity and a mobility management entity (MME). The satellite access apparatus (1000) can be, for example, but not limited to a Public Land Mobile Network (PLMN) and a Radio Access Technology (RAT). The UE (100) can be, for example, but not limited to, a smart phone, a laptop, a smart watch, an IoT device, a computer or the like.

The UE (100) registers to the satellite access apparatus (1000) through the satellite access network (700). Further, the UE (100) receives the discontinuous coverage wait range from the satellite access network (700) and detects the discontinuous coverage in the satellite access apparatus (1000). Further, the UE (100) determines the random wait time within the discontinuous coverage wait range. Based on the determination, the randomization controller (100) starts the wait timer configured with the determined random wait time, when the UE (100) returns to coverage after being out of coverage on the satellite access apparatus and waiting for the expiry or stop of the wait timer to initiate an access stratum (AS) signalling or a Non-access stratum (NAS) signalling on the satellite access network. The discontinuous coverage wait range is configured in the UE (100) by the satellite access network as part of at least one of a registration procedure, a UE configuration update procedure, a UE parameters update procedure, an attach procedure, a Tracking Area Update (TAU) procedure and a control plane procedure.

Further, the UE (100) detects the wait timer is running and waits to initiate the AS signalling or the NAS signalling on satellite access network (1000) when the wait timer is running.

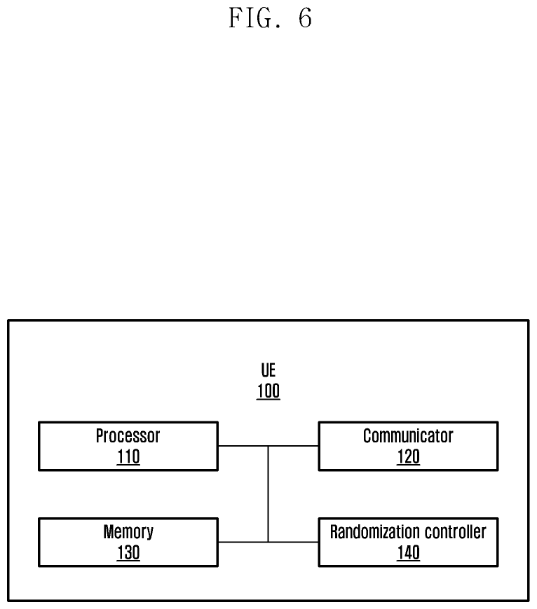

FIG. 6 shows various hardware components of the UE (100), according to the embodiments as disclosed herein. In an embodiment, the UE (100) includes a processor (110), a communicator (120), a memory (130) and a randomization controller (140). The processor (110) is coupled with the communicator (120), the memory (130) and the randomization controller (140).

The randomization controller (140) registers to the satellite access apparatus (1000) through the satellite access network (700). Further, the randomization controller (140) receives the discontinuous coverage wait range from the satellite access network (700) and detects the discontinuous coverage in the satellite access apparatus (1000). Further, the randomization controller (140) determines the random wait time within the discontinuous coverage wait range. Based on the determination, the randomization controller (140) starts the wait timer configured with the determined random wait time, when the UE returns to coverage after being out of coverage on the satellite access apparatus and waiting for the expiry or stop of the wait timer to initiate an access stratum (AS) signalling or a Non-access stratum (NAS) signalling on the satellite access network.

Further, the randomization controller (140) detects the wait timer is running and waits to initiate the AS signalling or the NAS signalling on satellite access network (1000) when the wait timer is running.

In another embodiment, the randomization controller (140) initiates the registration procedure for the satellite access. Further, the randomization controller (140) receives the discontinuous coverage wait range as part of registration procedure. Further, the randomization controller (140) detects the discontinuous coverage in the satellite access and computes the random wait time within the discontinuous coverage wait range. Further, the randomization controller (140) starts the wait timer configured with the determined random wait time based on the computation, when the UE (100) returns to coverage after being out of coverage on the satellite access apparatus (1000). The UE (100) will not initiate an access stratum (AS) signalling or a Non-access stratum (NAS) signalling for the satellite access till expiry of the wait timer or till the wait timer is stopped.

The randomization controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 6 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

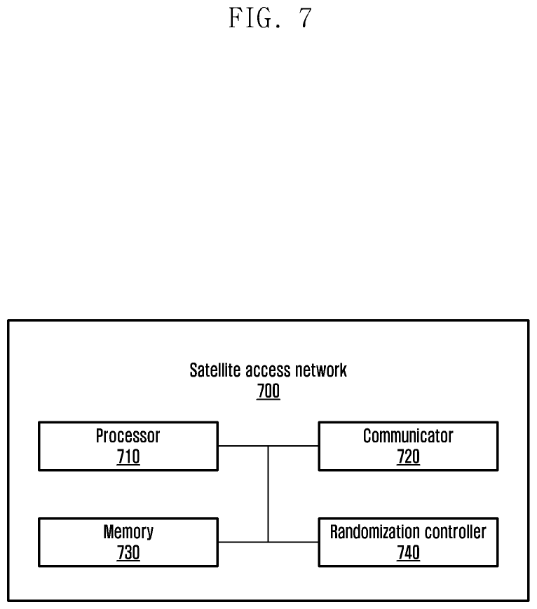

FIG. 7 shows various hardware components of the satellite access network (700), according to the embodiments as disclosed herein. In an embodiment, the satellite access network (700) includes a processor (710), a communicator (720), a memory (730) and a randomization controller (740). The processor (710) is coupled with the communicator (720), the memory (730) and the randomization controller (740).

The randomization controller (740) registers the UE (100) in the satellite access apparatus (1000). Further, the randomization controller (740) determines the discontinuous coverage wait range based on the network configuration. The network configuration can be on the basis of any parameters such as UE's subscription, UE(s)/User(s) priority, Type of UE(s)/User(s), Priority of the Services, Type of the services, Network deployment for Satellite Access or Terrestrial Access, Network load capability handling, Network Resource handling etc. For example—The discontinuous coverage wait range may be assigned by the Satellite Access Network based on the priority of the UE/Users or based on the priority/type of services for example- and/or as per UE's subscription data like Group ID or Type of Subscription or as per Access Identities or Access Categories or as per type of services (such as MCS or MPS etc). For e.g. Based on Priority of the UE(s)/User(s)/Services (i.e. or Group ID/Type of Subscription/Subscriber profile/Type of Services subscribed by the UE etc), the Network may assign a lesser or zero discontinuous coverage wait range to the higher priority UE(s)/User(s)/Services in comparison to high discontinuous coverage wait range to low priority UE(s)/User(s)/Services). Further, the randomization controller (740) sends the discontinuous coverage wait range to the UE (100) through a registration procedure with the UE (100) or a UE configuration update procedure. The UE (100) remains in no service during the discontinuous coverage to reduce signalling overload in the satellite access network and wait for expiry or stop of the wait timer to perform an alternate PLMN selection for normal services during the discontinuous coverage.

The randomization controller (740) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although the FIG. 7 shows various hardware components of the satellite access network (700) but it is to be understood that other embodiments are not limited thereon. In other embodiments, the satellite access apparatus (700) may include less or more number of components. Further, the labels or names of the components are used only for illustrative purpose and does not limit the scope of the invention. One or more components can be combined together to perform same or substantially similar function in the satellite access apparatus (700).

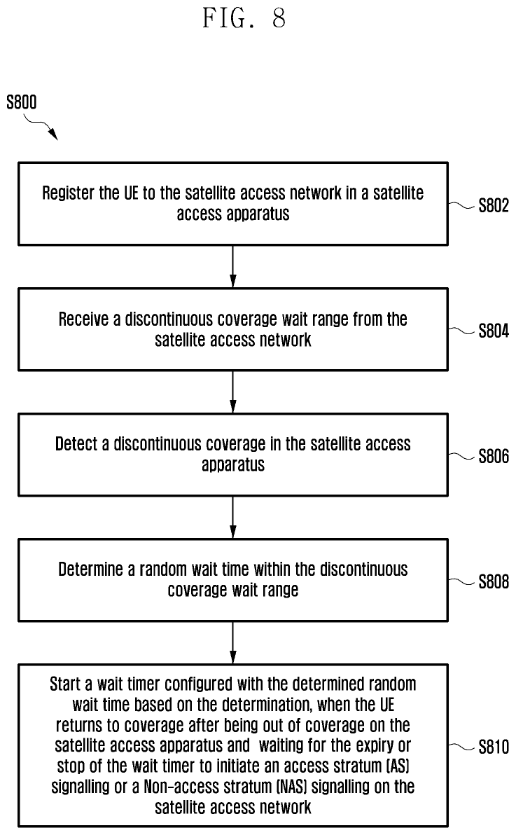

FIG. 8 is a flow chart (S800) illustrating a method, implemented by the UE (100), for randomizing the signalling during the discontinuous coverage area in the satellite access apparatus (1000), according to the embodiments as disclosed herein. The operations (S802-5810) are handled by the randomization controller (140).

At S802, The method includes registering the UE (100) to the satellite access network in the satellite access apparatus. At 804, the method includes receiving the discontinuous coverage wait range from the satellite access network. At S806, the method includes detecting a discontinuous coverage in the satellite access apparatus. At 808, the method includes determining the random wait time within the discontinuous coverage wait range. At 810, the method includes starting the wait timer configured with the determined random wait time based on the determination, when the UE (100) returns to coverage after being out of coverage on the satellite access apparatus and waiting for the expiry or stop of the wait timer to initiate an access stratum (AS) signalling or a Non-access stratum (NAS) signalling on the satellite access network. In an embodiment, the UE (100) may start the wait timer configured with the determined random wait time based on the determination, when the UE (100) is about to leave/before leaving the coverage of the source PLMN/RAT/Access/Network (i.e. to initiate any AS/NAS signalling to the source PLMN/RAT/Access/Network before leaving the coverage) or when the UE is about to enter the coverage of the target PLMN/RAT/Access/Network (i.e. to initiate any AS/NAS signalling to the target PLMN/RAT/Access/Network just after coming in the coverage of the target network) or when the UE (100) is returning to coverage of the same PLMN/RAT/Access/Network (i.e. to initiate any AS/NAS signalling to the same PLMN/RAT/Access/Network just after coming in the coverage of the same network from the discontinuous coverage)

In general, the method includes any information (for e.g. wait range information or any other information or any timer range information of any name) to be broadcasted or signalled or configured or pre-configured by any Network Element/Entity/Function in the UE. Further, the method includes determining by the UE, a wait time (or any time information of any name) within the wait range/timer range information signalled/configured by the network. Further, the method includes starting by the UE, a wait timer (or any timer information of any name) configured with the determined wait time (or any time information of any name) based on the determination when the UE returns to coverage after being out of coverage on the satellite access apparatus or when the UE moves to another/alternate Network/Access/RAT when determining being out of coverage on the satellite access apparatus or when the UE is about to go out of coverage on the satellite access apparatus or the source Network/RAT/Access. Further, the method includes waiting, by the UE, for the expiry or stop of the wait timer to initiate an access stratum (AS) signalling or a Non-access stratum (NAS) signalling on the satellite access network or any other Network/RAT/Access.

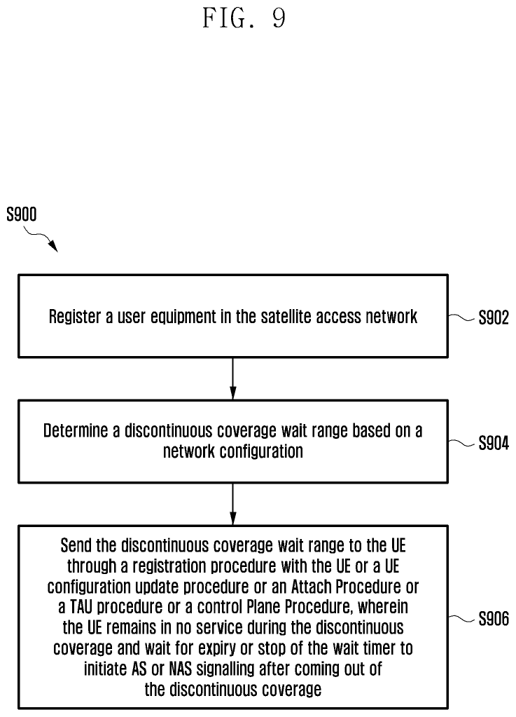

FIG. 9 is a flow chart (S900) illustrating a method, implemented by the satellite access apparatus (700), for randomizing the signalling during the discontinuous coverage area in the satellite access network, according to the embodiments as disclosed herein. The operations (S902-S906) are handled by the randomization controller (740).

At S902, The method includes registering the UE (100) in the satellite access network. At S904, the method includes determining the discontinuous coverage wait range based on network configuration. The network configuration can be on the basis of any parameters such as UE's subscription, UE (s)/User(s) priority, Type of UE(s)/User(s), Priority of the Services, Type of the Services, Network deployment for Satellite Access or Terrestrial Access, Network load capability handling, Network Resource handling etc. For example, the discontinuous coverage wait range may be assigned by the Satellite Access Network based on the priority of the UE (100)/Users or based on the priority/type of services for example—as per UE's subscription data like Group ID or Type of Subscription or as per Access Identities or Access Categories or as per type of services (such as MCS or MPS etc). For e.g. Based on Priority of the UE(s)/User(s)/Services (i.e. or Group ID/Type of Subscription/Subscriber profile/Type of Services subscribed by the UE etc), the Network may assign a lesser or zero discontinuous coverage wait range to the higher priority UE(s)/User(s)/Services in comparison to high discontinuous coverage wait range to low priority UE(s)/User(s)/Services). At S906, the method includes sending the discontinuous coverage wait range to the UE (100) through a registration procedure with the UE (100) or a UE configuration update procedure or an Attach Procedure or a TAU procedure or a control Plane Procedure, wherein the UE (100) remains in no service during the discontinuous coverage and wait for expiry or stop of the wait timer to initiate AS or NAS signalling after coming out of the discontinuous coverage.

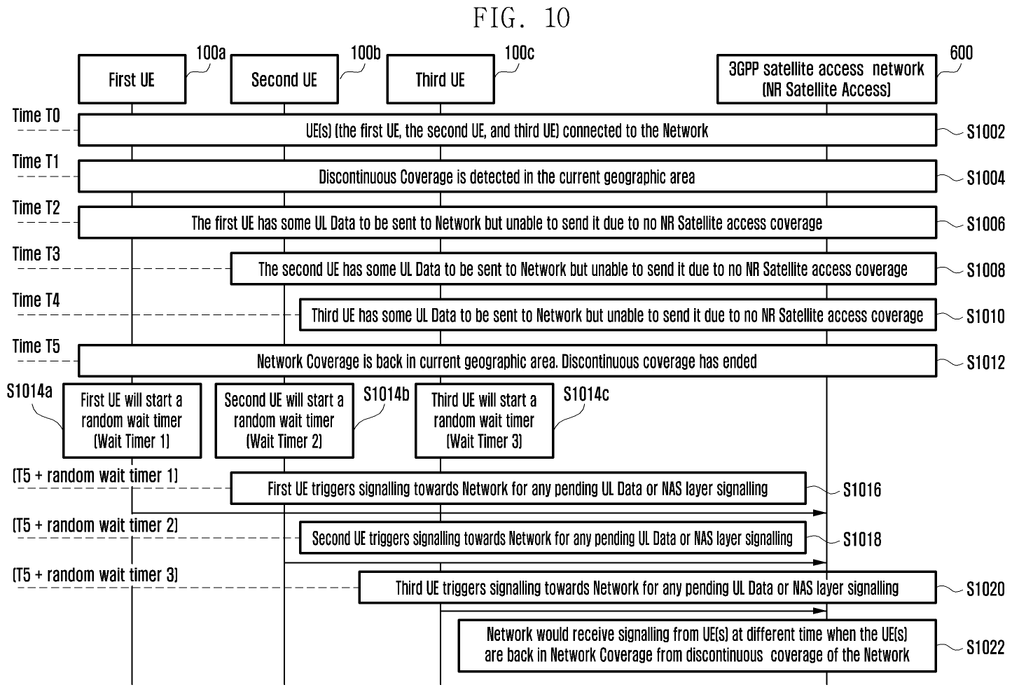

FIG. 10 illustrating an example scenario of how to ensure UE(s) (100a-100c) don't trigger signalling towards the network at the same time when the UE(s) (100a-100c) are out of discontinuous coverage of the NR satellite access network at the same time, according to the embodiments as disclosed herein.

Unlike to the conventional methods and systems, the UE(s) (100a-100c) using a NGRAN or eNodeB that provides a discontinuous coverage (e.g. for NR satellite access with discontinuous coverage) may be out of network coverage for a certain time (during discontinuous coverage of the NR Satellite Access network).

When the UE (100) determines that the Network Coverage is available after the discontinuous coverage or UE (100) wakes up and scans that Network Coverage is available after the discontinuous coverage, then UE (100) shall start a random timer/wait timer/or any timer of any name and wait for the random/wait timer to expire before triggering any signalling to the network. The wait timer or wait time or random time or any timer name can be defined as the restriction on the time put on the UE (100) when the UE (100) can initiate a registration or signalling (AS/NAS) procedure towards the network optionally this can be restricted for the scenario of discontinuous coverage. Similarly, when the UE (100) which was on one first RAT performs inter RAT movement to second RAT then UE (100) shall start a random timer/wait timer and wait for the random/wait timer to expire before triggering any AS/NAS signalling to the for available Network/RAT(s) in other 3GPP Access (for e.g. terrestrial access). That is, when there is a RAT change due to discontinuous coverage of satellite access even then the random/wait timer concept is applicable.

The random/wait timer/any timer or timer range of any name or any information may either be assigned by the Network (HPLMN or VPLMN) in any of the Access Stratum (AS)/Non-Access Stratum (NAS) signalling to the UE (100) before UE (100) goes into discontinuous coverage or the random/wait timer/any timer or timer range of any name or any information may be provisioned or stored in the UE (i.e., ME or USIM). Alternatively, the Network may assign an identifier to the UE (100) in any of the AS/NAS Signalling based on which UE (100) can calculate the random/wait timer.

The random/wait timer may be assigned by the Network or configured/provisioned in the UE (i.e., ME/USIM) based on the priority of the UE (100) as per UE's subscription data like Group ID or Type of Subscription (for e.g. Based on Subscription Data (Group ID/Type of Subscription/Subscriber profile/Type of Services subscribed by the UE etc), Network may assign a lesser or zero wait/random timer to the higher priority UE(s) in comparison to high wait/random timer to low priority UE(s)).

The random/wait timer may also be selected or determined by the UE (100) as per UE's implementation.

In an embodiment, the network (e.g., HPLMN or VPLMN) may provide a timer/any timer or timer range of any name or any information value to the UE (100), in any of the AS/NAS signalling before UE (100) goes into discontinuous coverage, based on which UE (100) may compute a series of Window of time when UE (100) can initiate any signalling to the Network. The UE (100) may only initiate a signalling during the time window frame for the first signalling initiated towards the network after coming into Network Coverage from discontinuous coverage. The UE (100) may determine/compute any value within the timer range signalled/configured by the Network based on any UE priority or any UE implementation way.

In an embodiment, the network may provide a minimum wait time/any timer or timer range of any name or any information to the UE (100) in any of the AS/NAS signalling before the UE (100) goes into discontinuous coverage. UE may initiate first signalling initiated towards the network after coming into Network Coverage from discontinuous coverage after any random time after the minimum wait timer has expired. The minimum wait timer is either started after the UE (100) goes into or comes out of discontinuous coverage. The timer is stopped, if already running, when the UE initiates any signalling towards the Network.

In an embodiment, the Network may provide a range of random/wait timer/any timer or timer range of any name or any information to the UE (100) in any of the AS/NAS signalling before the UE (100) goes into discontinuous coverage, based on which the UE (100) may compute (based on any network information or based on any UE implementation way) and start any random/wait timer/any timer of any name within this provided range of random/wait timer.

The random timer is stopped, if already running, whenever the UE (100) triggers a signalling to the network. The UE (100) shall wait for the random timer to expire (if already running) or shall start the random timer before triggering a response to the Network triggered signalling (for e.g. Paging Message or Service ReqUE(s)t or any other signalling) just after UE (100) comes back to the network coverage from the discontinuous coverage.

Alternatively, the UE (100) shall stop the wait timer or random timer (if already running) or shall not start the random timer/wait timer if UE (100) needs to trigger a response (for e.g. Paging Response Message or Service ReqUE(s)t message or any other signalling) to the Network triggered signalling (for e.g. Paging Message or Service ReqUE(s)t or any other signalling) just after the UE (100) comes back to Network coverage from the discontinuous coverage.

When the random or wait timer or wait range is not assigned by the Network or not configured in the UE (100), the UE (100) may not wait for any random time before triggering any signalling to the Network. Or there can be a separate configuration/indication in the UE (100) which indicates to the UE (100) whether UE (100) should apply the wait timer concept discussed in this embodiment. This separate configuration/indication can be configured by the network (e.g., HPLMN or the VPLMN) using any of the NAS or AS message like DL NAS TRANSPORT, UE configuration update etc.

In general, the method includes any information (for e.g. wait range information or any other information or any timer range information of any name) to be broadcasted or signalled or configured or pre-configured by any Network Element/Entity/Function in the UE. Further, the method includes determining by the UE, a wait time (or any time information of any name) within the wait range/timer range information signalled/configured by the network. Further, the method includes starting by the UE, a wait timer (or any timer information of any name) configured with the determined wait time (or any time information of any name) based on the determination when the UE returns to coverage after being out of coverage on the satellite access apparatus or when the UE moves to another/alternate Network/Access/RAT when determining being out of coverage on the satellite access apparatus or when the UE is about to go out of coverage on the satellite access apparatus or the source Network/RAT/Access. Further, the method includes waiting, by the UE, for the expiry or stop of the wait timer to initiate an access stratum (AS) signalling or a Non-access stratum (NAS) signalling on the satellite access network or any other Network/RAT/Access.

In yet another embodiment, Network shall randomize the DL Signalling or Network initiated signalling (for e.g. Paging or any signalling for any buffered DL Data for the UE) for different UE(s). This shall ensure that the UE's response or UL signalling is also randomized according to the DL Signalling or Network initiated signalling.

1. Alternatively, Network may start a random max wait timer (for e.g. different max wait timer for different UE(s)) and shall wait for the UE (100) initiated signalling or UL signalling and shall not trigger any DL Signalling or Network initiated signalling (for e.g. Paging or any signalling for any buffered DL Data for the UE) for the UE (100) until either the UE initiated signalling or UL signalling is received from the UE (100) or the max wait timer started by the Network for that UE (100) has expired.

2. The Network shall stop the max wait timer for the UE (100) whenever Network receives a UE initiated signalling or UL signalling from the UE (100). This shall ensure that the UL and DL signalling are synchronized with respect to time per UE (100).

The UE (100) shall select one or more of methods as above in any random order.

The terms random timer and wait timer have been interchangeably used and refer to the same thing. The wait timer or wait time or random time can be defined as the restriction on the time put on the UE (100) when the UE (100) can initiate a registration or signalling (AS/NAS) procedure towards the Network to send any of the signalling message or due to uplink data.

In this embodiment, The one, second RAT are one of the following RATs such as NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, LTE-M or the like.

As shown in FIG. 10, At S1002, all UE(s) (100a-100c) (the first UE, the second UE, and third UE) are connected to the 3GPP satellite access network (600). At S1004, the discontinuous coverage is detected in the current geographic area. At S1006, the first UE (100a) has some UL Data to be sent to the network (600) but unable to send it due to no NR satellite access coverage. At S1008, the second UE (100b) has some UL data to be sent to the network (600) but unable to send it due to no NR satellite access coverage. At S1010, the third UE (100c) has some UL data to be sent to the network (600) but unable to send it due to no NR satellite access coverage.

At S1012, the network coverage is back in the current geographic area. The discontinuous coverage has ended. At S1014a, the first UE (100a) will start the random wait timer (i.e., first wait timer). At S1014b, the second UE (100b) will start the random wait timer (i.e., second wait timer). At S1014c, the third UE (100c) will start the random wait timer (i.e., third wait timer). At S1016, the first UE (100a) triggers signalling towards the network (600) for any pending UL Data or NAS layer signalling. At S1018, the second UE (100b) triggers signalling towards the network (600) for any pending the UL Data or the NAS layer signalling. At S1020, the third UE (100c) triggers signalling towards the network (600) for any pending UL Data or NAS layer signalling. At S1022, the network (600) would receive signalling from UE(s) (100a-100c) at different time when the UE(s) (100a-100c) are back in the network coverage from the discontinuous coverage of the network (600).

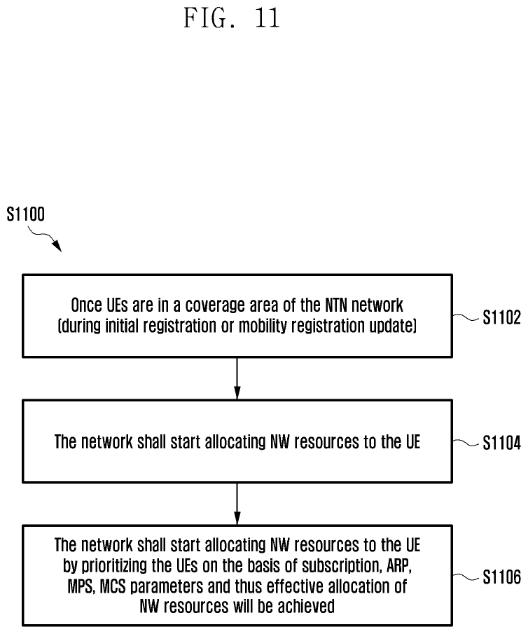

FIG. 11 depicts an example method for prioritizing UEs in a Non Terrestrial Network (NTN) coverage area, according to embodiments as disclosed herein.

At S1102, the Once UEs are in a coverage area of the NTN NW (during initial registration or mobility registration update). At S1104, the network shall start allocating NW resources to the UE (100). At S1106, NW shall start allocating NW resources to the UE (100) by prioritizing the UEs on the basis of subscription, Allocation and Retention Policy (ARP), Multimedia Priority Service (MPS), Mission Critical Service (MCS) parameters and thus effective allocation of NW resources will be achieved.

In another embodiment, when the UE (100) moves to coverage area of the NTN from the non-coverage area of the NTN, on the basis of subscription, ARP, MCS and MPS, the network (NW) shall start allocating NW resources to the UEs and start paging the UEs in the downlink. Once the UE (100) is in the coverage area of the Non Terrestrial Network (NTN), the network shall start allocating network resources on the basis of following parameters:

Subscription: This can be determined by the subscriber profile, which contains information about the services that are applicable to the user. The NTN shall allocate a service user with network resources aligning with their subscription level.

Allocation and Retention Priority (ARP): This is related to the Quality Of Service (QoS) of the bearer. At times of network congestion, the ARP value of a subscriber's bearer will determine whether or not it can replace an existing bearer that has a lower ARP precedence or be replaced by a new bearer with a higher ARP precedence. The NTN shall allocate a service user with network resources aligning with the ARP.

Multimedia Priority Service (MPS): This is a 3GPP feature designed to determine which priority treatment is applied for allocating and maintaining radio and network resources. The Network/system shall provide preferential treatment for access and core network resources associated with the session (i.e., signalling and media bearer related resources within a domain and across domains). A Service User is assigned a priority level by a regional/national authority i.e., agency authorised to issue priority levels. Upon MPS invocation, the calling service user's priority level is used to identify the priority to be used for the session being established.

Mission critical Service (MCS): Communication service providing enabling capabilities for Mission Critical Applications that are provided to end users from Mission Critical Organizations or other businesses and organizations (e.g., utilities, railways).

A Service User with MCS, shall be given priority for resource allocation.

In order to make sure that the UE (100) will send MO signalling request only in the coverage area, this solution uses the awareness of the UE (100) to derive periodic registration timer based on the coverage information.

If at a given geographical location, satellite coverage area periodicity (i.e. satellite again comes to the same location after pre-defined earth sweep) is known to the UE (100) (periodicity info shared via AMF), the UE (100) can determine the coverage area on the basis of its relative motion with the satellite.

When the UE (100) and satellite both are in motion in the same direction and are in comparatively similar speeds (i.e., the UE (100) speed will be lower than the speed of the satellite), the UE (100) can use buffer time with a periodic registration time for compensating for the delay in the coverage area.

$$Modified Periodic Registration Time = Periodic Registration Time + Buffer time$$

Similarly, when the UE (100) and satellite both are in motion in opposite directions and are in comparatively similar speeds (i.e., the UE (100) speed will be lower than the speed of the satellite), the UE (100) can use this buffer time with a periodic registration time for early coverage area.

$$Modified Periodic Registration Time = Periodic Registration Time - Buffer time$$

The purpose of prioritizing the UEs when UEs have the coverage of satellite after the specific time, is to use the NW resources effectively.

The various actions, acts, blocks, steps, or the like in the flow charts (S800, S900, and S1100) may be performed in the order presented, in a different order or simultaneously. Further, in some embodiments, some of the actions, acts, blocks, steps, or the like may be omitted, added, modified, skipped, or the like without departing from the scope of the invention.

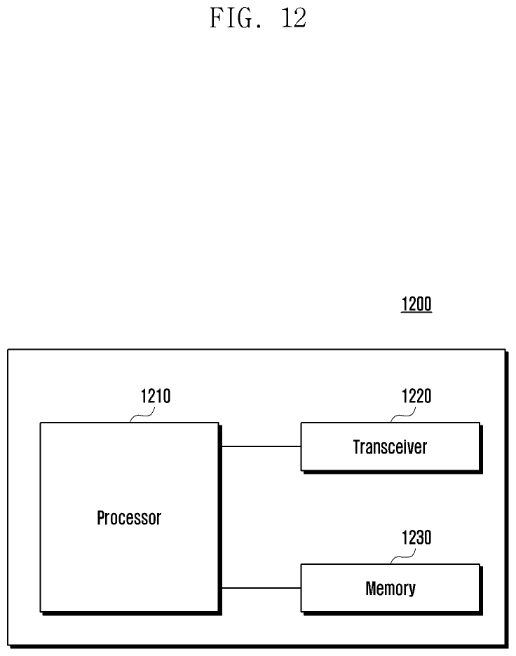

FIG. 12 illustrates an electronic device according to an embodiment of the disclosure.

Referring to the FIG. 12, the electronic device 1200 may include a processor 1210, a transceiver 1220 and a memory 1230. However, all of the illustrated components are not essential. The electronic device 1200 may be implemented by more or less components than those illustrated in FIG. 12. In addition, the processor 1210 and the transceiver 1220 and the memory 1230 may be implemented as a single chip according to another embodiment.

The electronic device 1200 may correspond to the UE described above.

The aforementioned components will now be described in detail.

The processor 1210 may include one or more processors or other processing devices that control the proposed function, process, and/or method. Operation of the electronic device 1200 may be implemented by the processor 1210.

The transceiver 1220 may include a RF transmitter for up-converting and amplifying a transmitted signal, and a RF receiver for down-converting a frequency of a received signal. However, according to another embodiment, the transceiver 1220 may be implemented by more or less components than those illustrated in components.

The transceiver 1220 may be connected to the processor 1210 and transmit and/or receive a signal. The signal may include control information and data. In addition, the transceiver 1220 may receive the signal through a wireless channel and output the signal to the processor 1210. The transceiver 1220 may transmit a signal output from the processor 1210 through the wireless channel.

The memory 1230 may store the control information or the data included in a signal obtained by the electronic device 1200. The memory 1230 may be connected to the processor 1210 and store at least one instruction or a protocol or a parameter for the proposed function, process, and/or method. The memory 1230 may include read-only memory (ROM) and/or random access memory (RAM) and/or hard disk and/or CDROM and/or DVD and/or other storage devices.

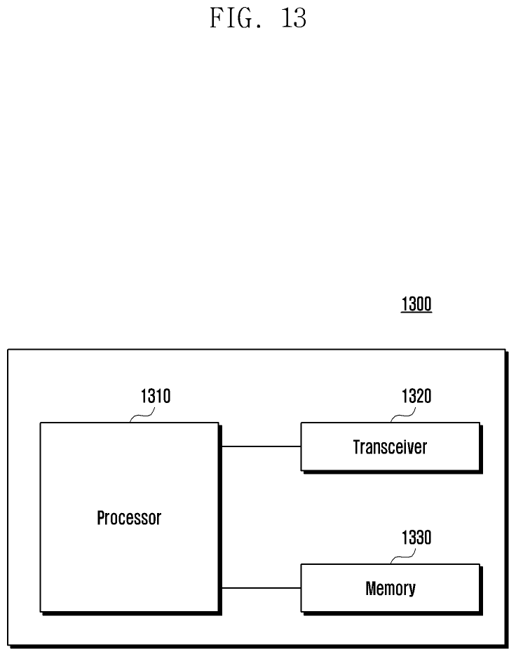

FIG. 13 illustrates a node according to an embodiment of the disclosure.

Referring to the FIG. 13, the node 1300 may include a processor 1310, a transceiver 1320 and a memory 1330. However, all of the illustrated components are not essential. The node 1300 may be implemented by more or less components than those illustrated in FIG. 13. In addition, the processor 1310 and the transceiver 1320 and the memory 1330 may be implemented as a single chip according to another embodiment.

The node 1300 may correspond to the gNB, the base station or a node in a network described above.

The aforementioned components will now be described in detail.

The processor 1310 may include one or more processors or other processing devices that control the proposed function, process, and/or method. Operation of the base station 1300 may be implemented by the processor 1310.

The transceiver 1320 may include a RF transmitter for up-converting and amplifying a transmitted signal, and a RF receiver for down-converting a frequency of a received signal. However, according to another embodiment, the transceiver 1320 may be implemented by more or less components than those illustrated in components.

The transceiver 1320 may be connected to the processor 1310 and transmit and/or receive a signal. The signal may include control information and data. In addition, the transceiver 1320 may receive the signal through a wireless channel and output the signal to the processor 1310. The transceiver 1320 may transmit a signal output from the processor 1310 through the wireless channel.

The memory 1330 may store the control information or the data included in a signal obtained by the base station 1300. The memory 1330 may be connected to the processor 1310 and store at least one instruction or a protocol or a parameter for the proposed function, process, and/or method. The memory 1330 may include read-only memory (ROM) and/or random access memory (RAM) and/or hard disk and/or CDROM and/or DVD and/or other storage devices.

According to an embodiment, a method for managing discontinuous satellite access by a User Equipment (UE) (100) may be provided.

According to an embodiment, the method may include registering, by the UE (100), for a satellite access apparatus (1000) through a satellite access network (700).

According to an embodiment, the method may include receiving, by the UE (100), a discontinuous coverage wait range from the satellite access network (700).

According to an embodiment, the method may include detecting, by the UE (100), a discontinuous coverage in the satellite access apparatus (1000).

According to an embodiment, the method may include determining, by the UE (100), a random wait time within the discontinuous coverage wait range.

According to an embodiment, the method may include starting, by the UE (100), a wait timer configured with the determined random wait time based on the determination, when the UE (100) returns to coverage after being out of coverage on the satellite access apparatus (1000) and waiting for the expiry or stop of the wait timer to initiate an access stratum (AS) signalling or a Non-access stratum (NAS) signalling to the satellite access network (700).

According to an embodiment, the satellite access network (700) may be at least one of an Access and Mobility Management Function (AMF) entity and a mobility management entity (MME), and wherein the satellite access apparatus (1000) is at least one of a Public Land Mobile Network (PLMN) and a Radio Access Technology (RAT).

According to an embodiment, the method may include detecting, by the UE (100), the wait timer is running.

According to an embodiment, the method may include waiting to initiate, by the UE (100), the AS signalling or the NAS signalling on satellite access network (700) when the wait timer is running.

According to an embodiment, the discontinuous coverage wait range may be configured in the UE (100) by the satellite access network (700) as part of at least one of a registration procedure, a UE configuration update procedure, a UE parameters update procedure, an attach procedure, a Tracking Area Update (TAU) procedure and a control plane procedure.

According to an embodiment, a method for managing discontinuous satellite access may be provided.

According to an embodiment, the method may include registering, by a satellite access network (700), a user equipment (UE) (100) in the satellite access apparatus (1000).

According to an embodiment, the method may include determining, by the satellite access network (700), a discontinuous coverage wait range based on a network configuration.

According to an embodiment, the method may include sending, by the satellite access network (700), the discontinuous coverage wait range to the UE (100) through at least one of a registration procedure, a UE configuration update procedure, a UE parameters update procedure, an attach procedure, a Tracking Area Update (TAU) procedure and a control plane procedure based on the determination, wherein the UE (100) remains in no service during the discontinuous coverage and waits for expiry or stop of the wait timer to initiate AS or NAS signalling after coming out of the discontinuous coverage.

According to an embodiment, the network configuration may include at least one of a priority of the UE (100), a type of the UE, a priority of a service, a type of the service, a UE's subscription, a network deployment for a satellite access or terrestrial access, a network load handling capability and network resource handling capability.

According to an embodiment, a method for managing discontinuous satellite access by a user equipment (UE) (100) may be provided.

According to an embodiment, the method may include initiating by the UE (100) a registration procedure for a satellite access.

According to an embodiment, the method may include receiving, by the UE (100), a discontinuous coverage wait range as part of registration procedure.

According to an embodiment, the method may include detecting, by the UE (100), a discontinuous coverage in the satellite access.

According to an embodiment, the method may include computing by the UE (100), a random wait time within the discontinuous coverage wait range.

According to an embodiment, the method may include starting, by the UE (100), a wait timer configured with the determined random wait time based on the computation, when the UE (100) returns to coverage after being out of coverage on the satellite access apparatus (1000), wherein the UE will not initiate an access stratum (AS) signalling or a Non-access stratum (NAS) signalling for the satellite access till expiry of the wait timer or till the wait timer is stopped.

According to an embodiment, a User Equipment (UE) (100) for managing discontinuous satellite access may be provided.

According to an embodiment, the UE (100) may include a memory (130); a processor (110); and a randomization controller (140), communicatively coupled to the memory (130) and the processor (110).

According to an embodiment, the randomization controller (140) may be configured to register to the satellite access apparatus (1000) through a satellite access network (700).

According to an embodiment, the randomization controller (140) may be configured to receive a discontinuous coverage wait range from the satellite access network (700).

According to an embodiment, the randomization controller (140) may be configured to detect a discontinuous coverage in the satellite access apparatus (1000).

According to an embodiment, the randomization controller (140) may be configured to determine a random wait time within the discontinuous coverage wait range.

According to an embodiment, the randomization controller (140) may be configured to start a wait timer configured with the determined random wait time based on the determination, when the UE (100) returns to coverage after being out of coverage on the satellite access apparatus and waiting for the expiry or stop of the wait timer to initiate an access stratum (AS) signalling or a Non-access stratum (NAS) signalling to the satellite access network (700).

According to an embodiment, a satellite access network (700) for managing discontinuous satellite access may be provided.

According to an embodiment, the satellite access network (700) may include a memory (730); a processor (710); and a randomization controller (740), communicatively coupled to the memory (730) and the processor (710).

According to an embodiment, the randomization controller (740) may be configured to register a user equipment (100) in the satellite access apparatus (1000).

According to an embodiment, the randomization controller (740) may be configured to determine a discontinuous coverage wait range based on network configuration.

According to an embodiment, the randomization controller (740) may be configured to send the discontinuous coverage wait range to the UE (100) through at least one of a registration procedure, a UE configuration update procedure, a UE parameters update procedure, an attach procedure, a Tracking Area Update (TAU) procedure and a control plane procedure, wherein the UE (100) remains in no service during the discontinuous coverage and wait for expiry or stop of the wait timer to initiate AS or NAS signalling after coming out of the discontinuous coverage.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a communication system, the method comprising:
identifying discontinuous coverage of a satellite access in a network being occurred;
identifying whether configuration information associated with a wait timer for the discontinuous coverage is configured or not;
in case that the configuration information associated with the wait timer is configured:
starting the wait timer with a random time, wherein the random time is within a provided range of the wait timer; and
initiating a signaling to the network after the wait timer is expired.

2. The method of claim 1, further comprising: in case that the configuration information associated with the wait timer is not configured, initiating the signaling to the network without waiting any random time.

3. The method of claim 1, wherein the signaling to the network is not initiated while the wait timer is running.

4. The method of claim 1, wherein the configuration information associated with the wait timer includes the provided range.

5. The method of claim 1, wherein the configuration information associated with the wait timer is configured by a home public land mobile network (HPLMN) associated with the network.

6. The method of claim 1, wherein the configuration information associated with the wait timer is configured based on a priority of the UE.

7. The method of claim 1, wherein the UE is configured to come back coverage of the network from the discontinuous coverage, and wherein a PLMN or a radio access technology (RAT) associated with the coverage is identified before starting the wait timer.

8. A user equipment (UE) in a communication system, the UE comprising:
a transceiver; and
a processor coupled with the transceiver and configured to:
identify discontinuous coverage of a satellite access in a network being occurred;
identify whether configuration information associated with a wait timer for the discontinuous coverage is configured or not;
in case that the configuration information associated with the wait timer is configured:
start the wait timer with a random time, wherein the random time is within a provided range of the wait timer; and
initiate a signaling to the network after the wait timer is expired.

9. The UE of claim 8, the processor is further configured to: in case that the configuration information associated with the wait timer is not configured, initiate the signaling to the network without waiting any random time.

10. The UE of claim 8, wherein the signaling to the network is not initiated while the wait timer is running.

11. The UE of claim 8, wherein the configuration information associated with the wait timer includes the provided range.

12. The UE of claim 8, wherein the configuration information associated with the wait timer is configured by a home public land mobile network (HPLMN) associated with the network.

13. The UE of claim 8, wherein the configuration information associated with the wait timer is configured based on a priority of the UE.

14. A method performed by a node in a communication system, the method comprising:
identifying a range for a wait timer, wherein a random time of the wait timer is within the range; and
transmitting, to a user equipment (UE), configuration information associated with the wait timer,
wherein in case that discontinuous coverage of a satellite access in a network including the node is occurred, a signaling is received from the UE after the wait timer with the random number is expired.

15. A node in a communication system, the node comprising:
a transceiver; and
a processor coupled with the transceiver and configured to:
identify a range for a wait timer, wherein a random time of the wait timer is within the range; and
transmit, to a user equipment (UE), configuration information associated with the wait timer,
wherein in case that discontinuous coverage of a satellite access in a network including the node is occurred, a signaling from the UE is received after the wait timer with the random number is expired.
